(19) United States
(12) Patent Application Publication
(10) Pub. No.: US 2025/0193614 A1
(43) Pub. Date: Jun. 12, 2025

(54) CONVERSION OF SPATIAL AUDIO SIGNALS TO TEXTUAL OR HAPTIC DESCRIPTION

(71) Applicant: SAP SE, Walldorf (DE)

(72) Inventors: Abhinav Kumar, Bengaluru (IN); Vikas Rohatgi, Bengaluru (IN)

(21) Appl. No.: 18/534,492

(22) Filed: Dec. 8, 2023

(51) Int. Cl. H04R 25/00; G10L 15/19; G10L 15/26

(52) U.S. Cl. CPC H04R 25/604; G10L 15/19; G10L 15/26; H04R 25/407; H04R 2225/61

(57) ABSTRACT

A spatial audio signal is received by a spatial audio processing engine which processes the spatial audio signal to extract one or more sound features. Next, the spatial audio processing engine interprets the one or more sound features. The one or more sound features may include a direction, a distance, and an intensity of each sound source of one or more sound sources captured by the spatial audio signal. Then, the spatial audio processing engine generates textual data and/or haptic stimuli based on the interpretation of the one or more sound features. The haptic stimuli may be encoded into signals that include vibrations corresponding to a first direction and a first intensity of a first sound source. Next, the spatial audio processing engine causes the textual data and/or the haptic stimuli to be sent to a user device for presentation to a hearing-impaired user.

### TECHNICAL FIELD

The present disclosure generally relates to making spatial audio signals more accessible to hearing-impaired users.

### BACKGROUND

Spatial audio enhances the perception of sound by creating a more immersive and three-dimensional (3D) listening experience. Spatial audio aims to replicate the way people hear sound in the real world, where sound sources come from various directions and distances. For example, stereo or surround sound systems, like 5.1 or 7.1 channel setups, can be used to playback spatial audio. This is often achieved using headphones or a small number of speakers strategically placed around the listener. However, hearing-impaired users are unable to perceive spatial audio content, depriving them of the ability to interact and engage with content that includes spatial audio signals.

### SUMMARY

In some implementations, a spatial audio signal is received by a spatial audio processing engine. The spatial audio processing engine processes the spatial audio signal to extract one or more sound features from the spatial audio signal. Next, the spatial audio processing engine interprets the one or more sound features. The one or more sound features may include a direction, a distance, and an intensity of each sound source of one or more sound sources captured by the spatial audio signal. Then, the spatial audio processing engine generates textual data and/or haptic stimuli based on the interpretation of the one or more sound features. The haptic stimuli may be encoded into one or more signals that include one or more vibrations that correspond to a first direction and a first intensity of a first sound source. Next, the spatial audio processing engine causes the textual data and/or the haptic stimuli to be sent to a user device to be presented to a hearing-impaired user.

Non-transitory computer program products (i.e., physically embodied computer program products) are also described that store instructions, which when executed by one or more data processors of one or more computing systems, causes at least one data processor to perform operations herein. Similarly, computer systems are also described that may include one or more data processors and memory coupled to the one or more data processors. The memory may temporarily or permanently store instructions that cause at least one processor to perform one or more of the operations described herein. In addition, methods can be implemented by one or more data processors either within a single computing system or distributed among two or more computing systems. Such computing systems can be connected and can exchange data and/or commands or other instructions or the like via one or more connections, including a connection over a network (e.g., the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims.

### BRIEF DESCRIPTION OF THE DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1 illustrates an example of a computing system, in accordance with some example implementations of the current subject matter;

FIG. 2 illustrates a block diagram of a spatial audio processing module, in accordance with some example implementations of the current subject matter;

FIG. 3 illustrates an example of a scene of a metaverse, in accordance with some example implementations of the current subject matter;

FIG. 4 illustrates a flow diagram of a process for implementing an audio processing sub-module of a module for analysis of spatial characteristics of sound within the audio;

FIG. 5 illustrates a flow diagram of a process for implementing a natural language processing (NLP) module;

FIG. 6 illustrates a flow diagram of a process for processing a spatial audio signal to extract one or more sound features;

FIG. 7A depicts an example of a system, in accordance with some example implementations of the current subject matter; and

FIG. 7B depicts another example of a system, in accordance with some example implementations of the current subject matter.

### DETAILED DESCRIPTION

Spatial audio enhances the perception of sound by creating a more immersive and three-dimensional (3D) listening experience. Spatial audio aims to replicate the way we hear sound in the real world, where sound sources come from various directions and distances. Some of the key aspects of spatial audio are the following: (1) Directionality: Spatial audio systems can make it seem as though sounds are coming from specific directions, allowing listeners to perceive the location of different audio sources in a virtual or physical environment. (2) Distance perception: In addition to directionality, spatial audio can also convey the sense of how far away a sound source is, creating a more realistic auditory experience. (3) Surround sound: Spatial audio can simulate surround sound systems.

Spatial audio has a wide range of applications, including virtual reality (VR) and augmented reality (AR) environments, the Metaverse, gaming, movies, music production, and live performances. Spatial audio can enhance immersion and realism in these contexts. Spatial audio, by its nature, relies on the perception of sound through hearing, making it primarily inaccessible to individuals who are deaf, hard of hearing, or deaf and blind. These individuals may be referred to herein as “hearing-impaired”.

The method and mechanisms described herein are intended to make spatial audio experiences more accessible to hearing-impaired individuals by incorporating alternative sensory modalities and technologies—like visual and textual captions and haptic feedback, through devices like wearables, gaming controllers, or specialized seats. For example, vibrations may be generated as haptic cues that correspond to the direction and intensity of sound sources, allowing users to perceive audio spatially through touch. Similarly, other haptic devices providing sensory modalities, such as tactile or visual feedback, may be used.

In an example, a high-level architecture of a computing system consists of the following: (1) audio input and (2) audio processing. The system begins with capturing a spatial audio signal. This audio is processed to extract spatial information, including the direction and intensity of sound sources. The audio processing component (i.e., audio processing module) analyses the audio input to determine the spatial characteristics of sound sources. The audio processing component extracts spatial information related to sound sources within the audio, such as the direction, distance, and intensity of those sources. Techniques such as binaural audio processing may be used to calculate the direction and distance of sound sources in a 3D space. Binaural audio processing implements algorithms that analyze audio signals to calculate the angles and distances of sound sources relative to the listener. The output of the audio processing module is spatial information, which includes data about the location and properties of sound sources. This information is then used to generate haptic feedback and provide context for a natural language processing (NLP) module. The NLP module focuses on processing the audio's linguistic content, transcribing the linguistic content into text, and generating textual descriptions that convey the meaning and context of the audio.

In an example, the audio signal is prepared for analysis by removing noise and by filtering and adjusting the audio signal. Algorithms like spectral subtraction, Wiener filtering, or adaptive filtering may be used for noise reduction. To determine the intensity or volume of sound sources, analysis of audio levels and amplitudes may be used. In order to estimate the distance of sound sources from the listener, algorithms based on signal intensity, attenuation, and environmental factors (in the case of virtual reality (VR) and the Metaverse) can be used.

For direction analysis in 3D space, techniques like beamforming, time-delay estimation, and Head-Related Transfer Functions (HRTFs) may be used. Beamforming is a spatial filtering technique used to enhance the signal of interest while suppressing interference and noise from other directions. Beamforming is primarily used for spatial filtering and source separation. Time-delay estimation (TDE) may be used to determine the time delay or phase difference between signals representing audio received by different microphones or sensors. TDE algorithms estimate the time delay between signals by analyzing the cross-correlation or phase differences between the signals. Time delays are often converted to angles or spatial coordinates to localize sound sources. HRTFs may be used to replicate the filtering and acoustic effects of the human head, outer ears (pinnae), and torso on sound as it travels from a source to the eardrums. HRTFs may be used to create spatial audio experiences that mimic human perception of sound direction and location. HRTFs may provide detailed directional information, allowing for accurate sound source localization and spatial audio rendering.

Spatial audio information may sometimes be non-text based, such as the sound of a passing train on the left-side of a user. In such cases, after pre-processing steps (e.g., noise reduction) have been performed, feature extraction may be implemented. In an example, an algorithm such as a Short-Time Fourier Transform (STFT) may be used to convert the audio segment into a spectrogram which represents the sound's frequency over time. After the spectrogram is generated, peak detection, amplitude analysis, amplitude modulation (variations in the loudness or intensity of a sound signal over time which helps in identifying rhythmic or periodic patterns in sounds), frequency analysis (examining the distribution of frequencies within an audio signal), and Doppler effect analysis (change in the frequency or pitch of a sound as a moving source approaches or recedes from the listener, to detect relative motion) may be performed on the spectrogram. Additional features may be extracted by analyzing spectral characteristics (pertaining to the frequency content) and temporal patterns (how the signal changes over time, capturing variations in amplitude and dynamics) in detail.

Various techniques and/or algorithms may be implemented for feature extraction, with the technique and/or algorithm varying according to the embodiment. In an example, frequency analysis may be performed, using a Fast Fourier Transform (FFT). The FFT is an algorithm which transforms a time-domain signal into the signal's frequency-domain representation. The FFT decomposes the signal into its constituent sinusoidal components. In another example, a Short-Time Fourier Transform (STFT) may be employed. The STFT computes the FFT for overlapping windows of the audio signal, enabling the analysis of frequency content over time. Additionally, spectral analysis may be employed. For example, techniques like spectrograms and power spectral density (PSD) plots may be generated so as to visualize the distribution of frequencies in the signal.

In various examples, amplitude analysis may also be performed on the spatial audio signal. Envelope detection methods track the variations in signal amplitude over time by extracting the envelope of the signal. Additionally, the Root Mean Square (RMS) value of a signal may be generated to measure the signal's average amplitude and may be used for dynamic range analysis. Amplitude modulation analysis may also be performed. For example, to analyze amplitude modulation, demodulation methods may be used to extract the modulating signal from the carrier signal. Also, envelope following techniques may be employed to track the variations in the envelope of the modulated signal. Additionally, Doppler effect analysis may be performed. The Doppler shift formula calculates the change in frequency based on the relative velocity between the source and the observer. By comparing the phase of a signal at different time points, the Doppler effect can be detected.

Still further, Mel-Frequency Cepstral Coefficients (MFCC) analysis may be performed. MFCCs are computed by applying a filterbank to the power spectrum of the audio signal. A filterbank is a collection of filters designed to partition the frequency spectrum into different frequency bands. These filters are designed to mimic the frequency sensitivity of the human auditory system, which is not linear but more sensitive to certain frequency regions. After applying the filterbank to the power spectrum of the audio signal, a logarithmic transformation and discrete cosine transform (DCT) are performed on the filtered audio signal. The logarithmic transformation approximates the logarithmic nature of human auditory perception. The DCT transforms a signal into a set of coefficients that capture the spectral characteristics of the signal. The MFCCs include a subset of this set of coefficients.

Subsequent to feature extraction being performed, deep learning-based pattern recognition and contextual analysis (e.g., context analysis of a scene in the metaverse) may be performed to interpret the extracted sound features. Contextual analysis may consider factors like the location, time of day, or other environmental cues that could influence the interpretation of the sound. Deep learning algorithms such as a recurrent neural network (RNN) or variants like Long Short-Term Memory (LSTM), Gated Recurrent Unit (GRU), or Transformer-based models (e.g., GPT or BERT) may be used.

Additionally, other contextual factors may be considered depending on the scene in which the spatial audio is generated. For example, in a workplace environment, if a boss is raising their voice when speaking to an employee, this may be detected based on the extracted sound features. The emotional context of this scene may be conveyed to a user via increased vibrations on a haptic device, via text generated in bold or in all capital letters, or via other suitable stimuli. In another context, such as a conference room crowded with many people, the direction from which a particular person is speaking may be detected and then conveyed to a hearing-impaired user based on vibrations in a particular area of a haptic device to inform the user. When multiple people are speaking at the same time in the conference room, the vibrations may be generated in multiple different areas of the haptic device to let the user know that multiple people are attempting to speak. This may alert the user to a particular emotionally charged discussion that is creating a cacophony of speech from multiple users concurrently.

In an example, natural language processing (NLP) techniques may be employed. In this example, the audio content is transcribed into text using speech recognition technology and textual descriptions are generated that convey the content to the user. The NLP techniques provide a textual representation of the audio content and any relevant context. NLP techniques may be employed to analyze and understand text and identify different sound sources, including the attributes of the sound sources and any contextual information (e.g., dialogue, environmental sounds).

To convert spoken words from audio into text, algorithms and tools for speech recognition include Deep Learning models such as Convolutional Neural Networks (CNNs) and RNNs may be used. Furthermore, Natural Language Understanding (NLU) techniques may be implemented. In an example, NLU is implemented to generate more meaningful and contextually relevant textual descriptions. Also, NLU may be implemented to summarize and condense lengthy spoken content into shorter, more concise textual representations, making it easier for users to digest the information.

In an example, Named Entity Recognition (NER) may be utilized to identify and classify named entities in text into predefined categories such as person names, organization names, and so on. Also, a Part-of-Speech Tagging process may be employed to assign a grammatical category or part-of-speech label to each word in a sentence. The labels represent the word's syntactic role in the sentence, such as noun, verb, adjective, adverb, pronoun, and the like. Additionally, Sentiment Analysis may be used to extract information and context from the text.

In an example, a computing system may include both an audio processing module and a NLP module. In this example, the audio processing module focuses on analyzing the spatial characteristics of sound within the audio signal, providing data related to the location and properties of sound sources. The NLP module, on the other hand, focuses on processing the audio's linguistic content, transcribing the linguistic content into text, and generating textual descriptions that convey the meaning and context of the audio.

In an example, the spatial information obtained from audio processing is used to generate haptic feedback. Haptic feedback may be generated using various technologies, including vibration motors, tactile actuators, or even more advanced haptic devices like haptic gloves or vests. The intensity, duration, and frequency of vibrations may be controlled based on the spatial audio data. For mapping the direction and intensity of sound sources to specific haptic actuators, trigonometric calculations may be performed to determine actuator activation.

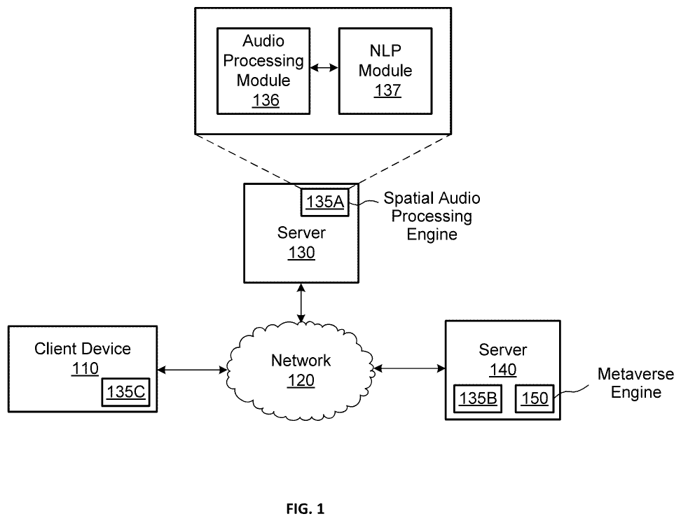

Referring now to FIG. 1, a block diagram illustrating an example of a computing system 100 is depicted, in accordance with some example embodiments. In FIG. 1, the system 100 may include at least one or more client devices 110, a network 120, one or more servers 130, and one or more servers 140. Server 130 is shown as including spatial audio processing engine 135A. It is noted that spatial audio processing engine 135A may also be referred to as a spatial audio module. In an example, at least a portion of the functionality of spatial audio processing engine 135A resides in sub-component 135B of server 140 and/or at least a portion of the functionality of spatial audio processing engine 135A resides in sub-component 135C of client device 110. In other words, in some examples, the overall functionality of a spatial audio processing engine may be split up (i.e., partitioned) into specific functions that are performed in multiple locations. In other examples, the overall functionality of a spatial audio processing engine may contained within a single module.

The one or more client devices 110, the one or more servers 130, and the one or more servers 140 may be communicatively coupled via a network 120. The one or more client devices 110 may include processor-based devices including, for example, a mobile device, a wearable apparatus, a virtual reality (VR) or augmented reality (AR) headset, a personal computer, a workstation, an Internet-of-Things (IoT) appliance, and/or the like. The network 120 may be a wired network and/or wireless network including, for example, a public land mobile network (PLMN), a local area network (LAN), a virtual local area network (VLAN), a wide area network (WAN), the Internet, and/or the like.

The one or more servers 130 and 140 may include any number of processing devices, memory devices, and/or the like for executing software applications. Server 130 and/or server 140 may be part of a private computing platform or part of a public cloud platform, depending on the implementation. The cloud platform may include resources, such as at least one computer (e.g., a server), data storage, and a network (including network equipment) that couples the computer(s) and storage. The cloud platform may also include other resources, such as operating systems, hypervisors, and/or other resources, to virtualize physical resources (e.g., via virtual machines) and provide deployment (e.g., via containers) of applications (which provide services, for example, on the cloud platform, and other resources). In the case of a “public” cloud platform, the services may be provided on-demand to a client, or tenant, via the Internet. For example, the resources at the public cloud platform may be operated and/or owned by a cloud service provider (e.g., Amazon Web Services, Azure), such that the physical resources at the cloud service provider can be shared by a plurality of tenants. Alternatively, or additionally, the cloud platform may be a “private” cloud platform, in which case the resources of the cloud platform may be hosted on an entity's own private servers (e.g., dedicated corporate servers operated and/or owned by the entity). Alternatively, or additionally, the cloud platform may be considered a “hybrid” cloud platform, which includes a combination of on-premises resources as well as resources hosted by a public or private cloud platform. For example, a hybrid cloud service may include web servers running in a public cloud while application servers and/or databases are hosted on premise (e.g., at an area controlled or operated by the entity, such as a corporate entity).

Server 140 may include a metaverse engine 150 for generating a metaverse including various immersive scenes for one or more users of client device 110 to interact with. In other embodiments, server 140 may include other engines or modules for generating other types of content. Metaverse engine 150 may also be referred to as metaverse platform 150. In other examples, server 140 may include other engines for generating other types of immersive content besides the metaverse. As part of generating the metaverse or other entertainment content, server 140 may generate a spatial audio signal. Server 130 includes spatial audio processing engine 135A which receives, processes, and analyzes the spatial audio signal generated for the immersive content. Based on the processing and analysis, spatial audio processing engine 135A generates a textual description and/or haptic stimuli for one or more hearing-impaired users of client device 110.

It is noted that spatial audio processing engine 135A may be implemented using any suitable combination of program instructions, firmware, and/or circuitry. In an example, spatial audio processing engine 135A is implemented by a processing device (e.g., central processing unit (CPU), graphics processing unit (GPU)) executing program instructions. In another example, spatial audio processing engine 135A is implemented by a programmable logic device (e.g., field programmable gate array (FPGA)). In a further example, spatial audio processing engine 135A is implemented by dedicated circuitry (e.g., application specific integrated circuit (ASIC)). In a still further example, spatial audio processing engine 135A is implemented by any combination of the above mechanisms and/or with other types of circuitry and executable instructions. Spatial audio processing engines 135B-C may also be implemented according to any of the above-mentioned examples.

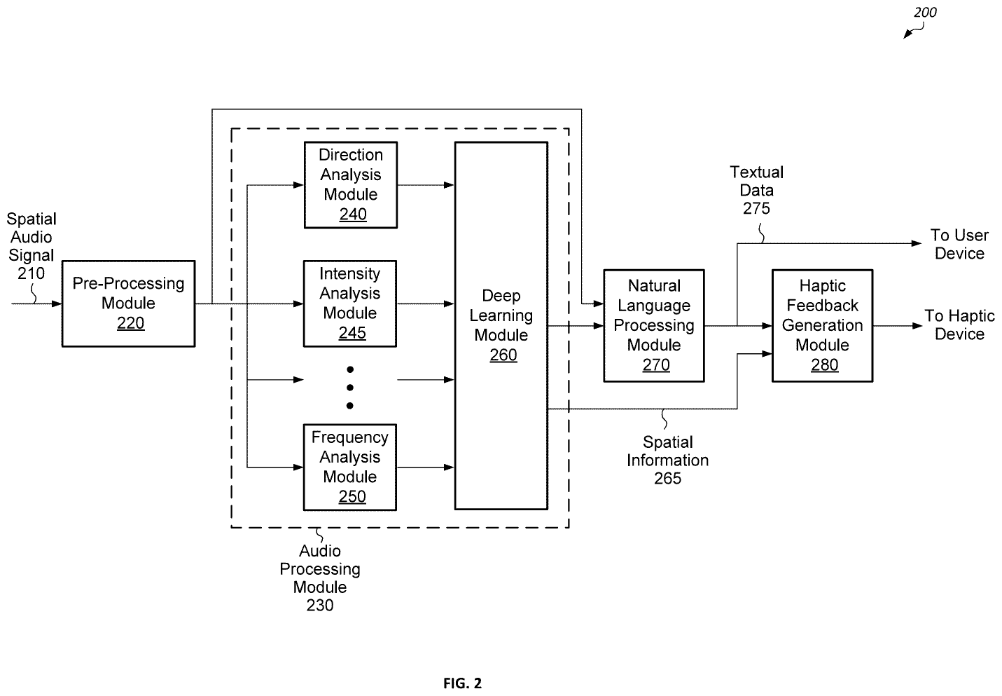

Turning now to FIG. 2, a block diagram of components of a spatial audio processing module 200 for implementing one or more of the techniques described herein is shown. Spatial audio processing module 200 may be configured to process audio rendered in a three-dimensional (3-D) space which provides users with a realistic and immersive auditory experience. The spatial audio signal 210 aims to replicate how sound behaves in the real world, taking into consideration factors such as distance, direction, and environmental effects (e.g., the sound of a passing train). In an example, the spatial audio processing module 230 along with Natural language processing (NLP) module 270 may process spatial audio signal 210 so as to provide a textual description of sound to be consumed by a hearing-impaired user using a haptic device. Spatial audio processing module 200 may be implemented as part of a server (e.g., server 130 of FIG. 1), as part of a cloud platform, as part of a computing device, or as a standalone component. It is noted that spatial audio processing module 200 may correspond to spatial audio processing engine 135A of FIG. 1. In other words, in an example, spatial audio processing engine 135A may include the components and/or functionality of spatial audio processing module 200.

As shown in FIG. 2, spatial audio processing module 200 receives a spatial audio signal 210 which is pre-processed by pre-processing module 220. Pre-processing module 220 may prepare the spatial audio signal 210 for analysis by removing noise, filtering, and adjusting the spatial audio signal 210. The output of pre-processing module 220 may be referred to as a filtered spatial audio signal or as a pre-processed spatial audio signal.

The output of pre-processing module 220 may be provided to audio processing module 230. Audio processing module 230 focuses on analyzing spatial characteristics of sound within the audio and providing data related to the location and properties of sound sources. Audio processing module 230 may process the pre-processed spatial audio signal via various algorithms to extract one or more environmental features which can provide details of an environment in which the spatial audio signal 210 was captured. For example, these details on the non-textual information may include determining that the sound of a passing train is embedded in the spatial audio signal 210, determining that the sound of a stationary ship in port is embedded in the spatial audio signal 210, determining that the sound of a dog barking is embedded in the spatial audio signal 210, and so on.

Audio processing module 230 may include any number of modules such as direction analysis module 240, intensity analysis module 245, and frequency analysis module 250. In other embodiments, audio processing module 230 may include other numbers and types of modules for analyzing the pre-processed spatial audio signal. For example, these other modules may include a Doppler Effect analysis module, a Mel-Frequency Cepstral Coefficients (MFCC) analysis module, and others. Each of direction analysis module 240, intensity analysis module 245, and frequency analysis module 250 may include any number of sub-modules for performing the analysis. The results of the analysis performed by direction analysis module 240, intensity analysis module 245, and frequency analysis module 250 are provided as inputs to deep learning module 260. It is noted that direction analysis module 240, intensity analysis module 245, and frequency analysis module 250 may be referred to more generally as feature extraction modules as their role is to extract different types of sound features from the pre-processed spatial audio signal.

Deep learning module 260 receives the sound features extracted from the pre-processed spatial audio signal, and deep learning module 260 performs pattern recognition and/or contextual analysis to interpret the extracted sound features. Contextual analysis (e.g., in the case of the metaverse, the context may be coming from the metaverse scene) may consider factors such as location, time of day, and/or other environmental cues that can influence the interpretation of the sound. Deep learning module 260 may utilize deep learning algorithms such as recurrent neural networks (RNNs), Long Short-Term Memory (LSTM), Gated Recurrent Unit, Transformer-based models, or otherwise for interpreting the extracted sound features.

Natural language processing (NLP) module 270 is configured to transcribe the audio content into text using speech recognition technology to extract meaningful information. NLP module 270 may generate textual descriptions that convey the meaning of the audio content to the user. In other words, NLP module 270 provides a textual representation of the audio content and any relevant context. NLP module 270 receives as inputs the pre-processed spatial audio signal and the outputs from the deep learning model 260. NLP module 270 may employ NLP techniques to analyze and understand text, identifying different sound sources, sound source attributes, and corresponding contextual information. NLP module 270 focuses on processing the linguistic content of audio, transcribing the linguistic content into text, and generating textual descriptions that convey the meaning and context of the audio.

In an example, if someone is shouting from the left side of a user, audio processing module 230 will determine that someone is shouting based on the analysis performed by intensity analysis module 245, and audio processing module 230 will determine that the shouting is coming from the left side based on the analysis performed by direction analysis module 240. Audio processing module 230 will provide the intensity (i.e., shouting) and direction (i.e., left) cues. In this example, NLP module 270 will convert the shouted text into a caption or braille output. In some cases, there may be a separate sub-module that provides haptic outputs such as a braille output for a refreshable braille unit for blind and deaf users. In another example, in the case of non-textual information such as a train passing by on the left side, audio processing module 230 will utilize feature analyze to determine that there is a sound coming from the direction of the left side and that the sound is identified as being generated by a passing train. In a further example, if the context of the spatial audio signal 210 is an office environment, and if audio processing module 230 extracts features from the spatial audio signal 210 that are interpreted as indicative of a boss shouting, then this information of the boss shouting in the office may be included in the generated text and/or haptic output. Other example scenarios may be processed by audio processing module 230 and NLP module 270 in similar suitable manners.

Haptic feedback generation module 280 is configured to receive as inputs the textual data 275 generated by NLP module 270 and the spatial information 265 generated by deep learning module 260. Haptic feedback generation module 280 uses these inputs to generate haptic feedback which is provided to a haptic device. Haptic feedback may be generated using various technologies including, but not limited to, vibration motors, tactile actuators, haptic gloves, and haptic vests. Haptic feedback generation module 280 may utilize algorithms that involve controlling the intensity, duration, and frequency of vibrations based on the spatial information 265 and/or textual data 275.

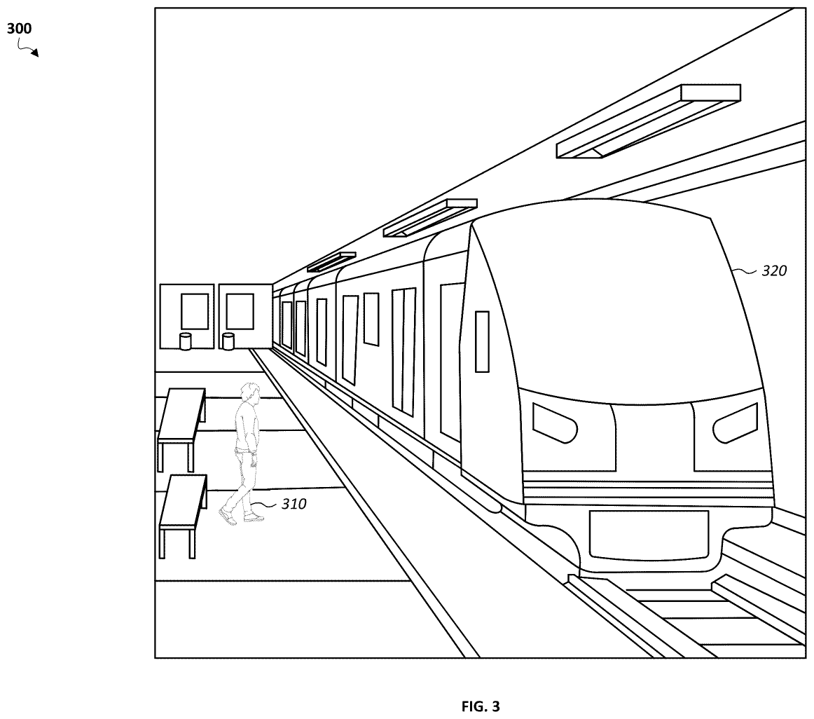

Turning now to FIG. 3, a diagram illustrating an example of a scene 300 is shown. Scene 300 is an example of a scene that may be generated in a metaverse, virtual reality environment, augmented reality environment, or otherwise. As depicted, scene 300 shows an avatar 310 (representing a user) in a train station. The proximity alert generation mechanism previously described may be utilized by a navigation assistance module to alert the user as the avatar 310 approaches the train 320. For example, the direction and orientation of the avatar 310 may be determined or received by a navigation assistance module and/or a context analysis module. Also, the location of the train 320 may be determined by a navigation assistance module and/or a context analysis module.

The context of scene 300 may be used by a spatial audio processing module (e.g., spatial audio processing module 200 of FIG. 2) to generate textual data and/or haptic feedback to alert a hearing-impaired user to the location of the train relative to avatar 310. In a real-life context, with a user next to a train 320, the textual data and/or haptic feedback may alert the user to the approach of the train 320 and based on an analysis of the sound, determine which side of the user the train 320 is approaching from. For example, if the train 320 is approaching the user on the left-side, this may be indicated by vibrating a left portion of a haptic device. Or, if the train 320 is approaching the user on the right-side, this may be indicated by vibrating a right portion of a haptic device. Additionally, if the train 320 is approach at a relatively high speed, this may be indicated by increasing a frequency of the vibration on the haptic device. Other ways of indicating the location, speed, or other characteristics associated with the approach of the train (or other types of moving objects) to a user via a haptic device are possible and are contemplated.

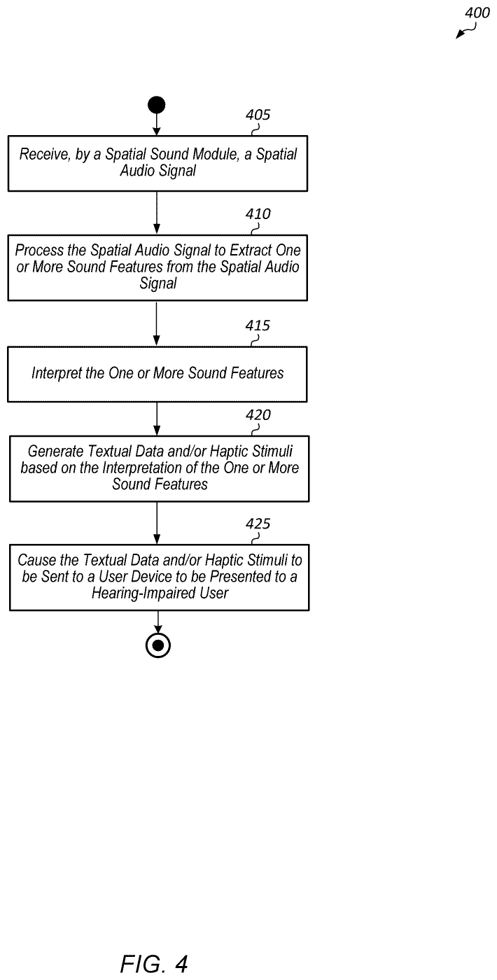

Referring now to FIG. 4, a flow diagram illustrating a process for implementing an audio processing sub-module of a spatial sound module for analysis of spatial characteristics of sound within the audio is shown. At the beginning of method 400, a spatial sound module receives a spatial audio signal (block 405). As used herein, the term “audio signal” may be defined as a digital or analog electrical signal representing audio information. In particular, the systems and methods described herein do not require a conversion of the audio signal into sound waves. Instead, the systems and methods described herein may consume an electrical signal representing audio information. In an example, the spatial audio signal is captured from a metaverse scene. In other examples, the spatial audio signal is captured from other sources (e.g., conference call, video call, virtual reality (VR) content, augmented reality (AR) content).

Next, the spatial sound module processes the spatial audio signal to extract one or more sound features from the spatial audio signal (block 410). The one or more sound features may include various auditory and spatial information, such as a direction, a distance, frequency, change in frequency for moving objects, and an intensity of each sound source of one or more sound sources captured by or encoded in the spatial audio signal.

Then, the spatial audio module interprets the one or more sound features (block 415). In an example, the spatial audio module may employ a deep learning module which is pre-trained with various sound features to be able to identify what objects and/or events caused the one or more sound features to be generated. For example, a truck engine corresponds to a first type of sound feature, a train passing by corresponds to a second type of sound feature, a ship coming into a port corresponds to a third type of sound feature, and so on. Additionally, in an example, contextual analysis may be performed to determine the context of a particular scene from which the spatial audio signal was extracted. The context may include the location, time of day, and other parameters associated with the particular scene.

Next, the spatial audio module generates textual data and/or haptic stimuli based on the interpretation of the one or more sound features (block 420). The haptic stimuli (i.e., haptic feedback) is generated to capture the sound features and/or other spatial information in a manner that generates localized bodily sensations for the user which conveys the intended impression of the extracted sound features. Next, the spatial audio module causes the textual data and/or the haptic stimuli to be sent to a user device to be presented to a hearing-impaired user (block 425). In an example, the spatial audio module may encode the haptic feedback into one or more signals. For example, various waveforms may be generated based on the haptic feedback, and these waveforms are used to modulate the one or more signals. Any of various suitable types of modulation may be used, with the type of modulation varying from embodiment to embodiment. Then, the spatial audio module may drive the one or more signals to a haptic interface (i.e., haptic component) of the user device. Driving the signal(s) to the haptic device creates one or more localized tactile sensations on the haptic devices for the end-user, with the localized tactile sensations conveying an impression of the content of the spatial audio signal to the end-user. After block 425, method 400 ends.

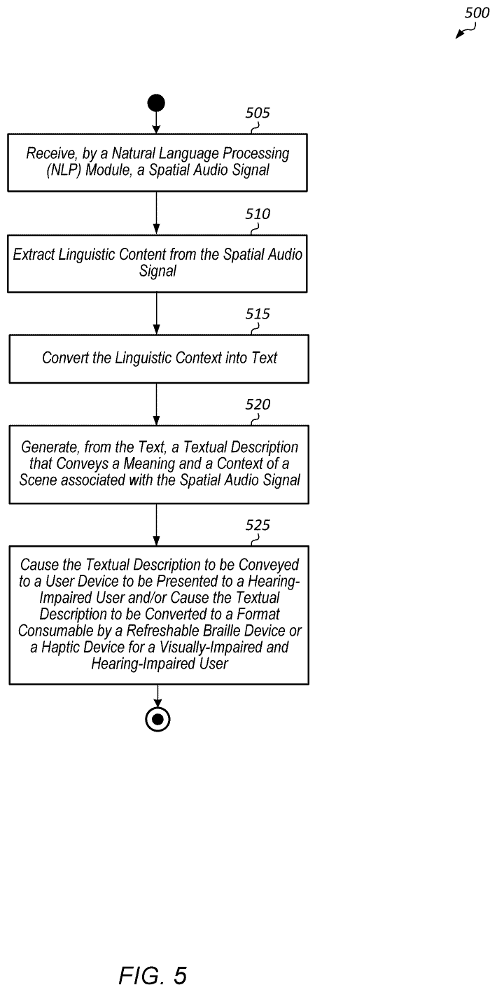

Turning now to FIG. 5, a flow diagram illustrating a process for implementing a natural language processing (NLP) module is shown. At the beginning of method 500, a NLP module receives a spatial audio signal (block 505). In an example, the spatial audio signal is associated with a scene of a metaverse. In other examples, the spatial audio signal is associated with other types of content. Next, the NLP module extracts linguistic content from the spatial audio signal (block 510). Then, the NLP module converts the linguistic content into text (block 515). Next, the NLP module generates, from the text, a textual description that conveys a meaning and a context of a scene associated with the spatial audio signal (block 520). In an example, the NLP module includes a natural language understanding (NLU) module that generates the textual description from the text. The NLU module is configured to generate more meaningful and contextually relevant textual descriptions. The NLU module is also configured to summarize and condense lengthy spoken content into shorter, more concise textual representations, making it easier for users to digest the information. After block 520, the NLP module causes the textual description to be conveyed to a user device to be presented to a hearing-impaired user and/or causes the textual description to be converted to a format consumable by a refreshable braille device or a haptic device for a visually-impaired and hearing-impaired user (block 525). After block 525, method 500 ends.

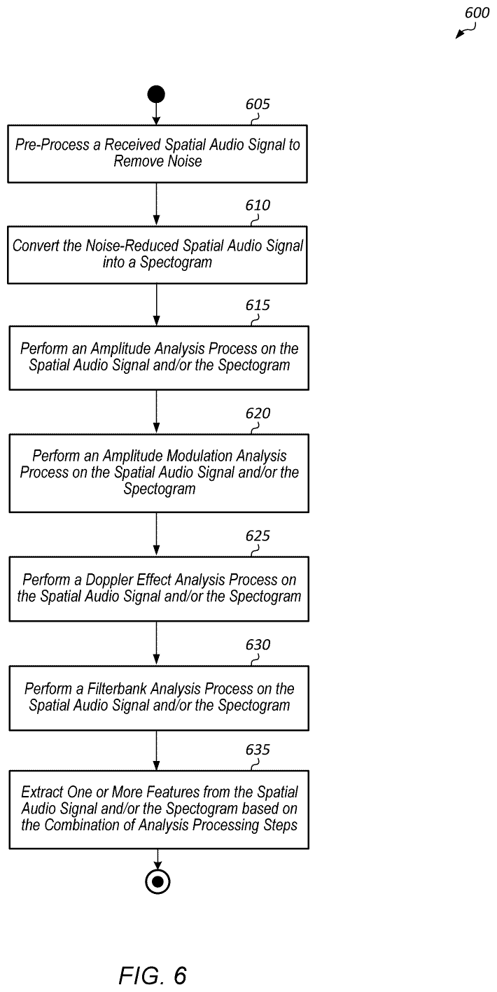

Referring now to FIG. 6, a flow diagram illustrating a process for processing a spatial audio signal to extract one or more sound features is shown. At the start of method 600, a spatial sound module pre-processes (i.e., filters) a received spatial audio signal to remove noise (block 605). Any of various noise-reduction or noise-cancelling techniques may be employed to pre-process the received spatial audio signal. Next, the spatial sound module converts the noise-reduced spatial audio signal into a spectrogram (block 610). The spectrogram represents the sound's frequency over time. In an example, a short-time fourier transform (STFT) is used to convert the spatial audio signal into the spectrogram. In another example, a fast fourier transform (FFT) is utilized to convert the spatial audio signal into the spectrogram.

Then, an amplitude analysis process may be performed on the spatial audio signal and/or the spectrogram (block 615). The amplitude analysis process may include an envelope detection method to track variations in the signal amplitude over time by extracting the envelope of the signal. The amplitude analysis process may also include calculating the root mean square (RMS) value of the spatial audio signal to measure the signal's average amplitude. Next, an amplitude modulation analysis process may be performed on the spatial audio signal and/or the spectrogram (block 620). In an example, a demodulation technique may be employed to extract a modulating signal from a carrier signal. Additionally, in another example, envelope following techniques may be utilized to track variations in the envelope of a modulated signal.

Then, a Doppler effect analysis process may be performed on the spatial audio signal and/or the spectrogram (block 625). In an example, a Doppler shift formula may be used to calculate the change in frequency of an audio signal embedded in the spatial audio signal based on the relative velocity of the source of the audio signal and an observer. In another example, the phase of the audio signal may be compared at different time points to detect the Doppler effect. Next, a filterbank analysis process may be performed on the spatial audio signal and/or the spectrogram (block 630). In an example, mel-frequency cepstral coefficients (MFCCs) are computed by applying filterbanks to the spatial audio signal and/or the spectrogram. These filterbanks mimic the frequency sensitivity of the human auditory system. Then, one or more features may be extracted from the spatial audio signal and/or the spectrogram based on the combination of analysis processing steps (block 635). After block 635, method 600 may end.

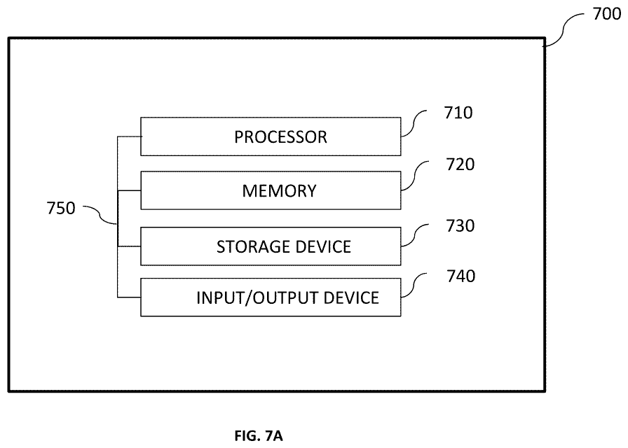

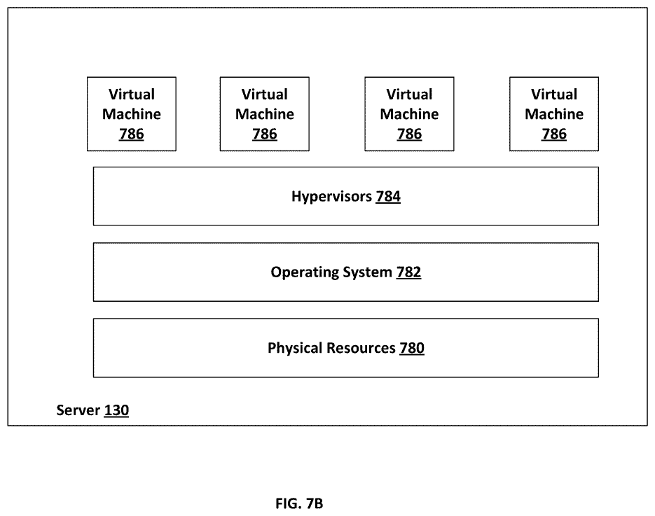

In some implementations, the current subject matter may be implemented in a system 700, as shown in FIG. 7A. The system 700 may include a processor 710, a memory 720, a storage device 730, and an input/output device 740. Each of the components 710, 720, 730 and 740 may be interconnected using a system bus 750. The processor 710 may be configured to process instructions for execution within the system 700. In some implementations, the processor 710 may be a single-threaded processor. In alternate implementations, the processor 710 may be a multi-threaded processor. The processor 710 may be further configured to process instructions stored in the memory 720 or on the storage device 730, including receiving or sending information through the input/output device 740. The memory 720 may store information within the system 700. In some implementations, the memory 720 may be a computer-readable medium. In alternate implementations, the memory 720 may be a volatile memory unit. In yet some implementations, the memory 720 may be a non-volatile memory unit. The storage device 730 may be capable of providing mass storage for the system 700. In some implementations, the storage device 730 may be a computer-readable medium. In alternate implementations, the storage device 730 may be a floppy disk device, a hard disk device, an optical disk device, a tape device, non-volatile solid state memory, or any other type of storage device. The input/output device 740 may be configured to provide input/output operations for the system 700. In some implementations, the input/output device 740 may include a keyboard and/or pointing device. In alternate implementations, the input/output device 740 may include a display unit for displaying graphical user interfaces.

FIG. 7B depicts an example implementation of the server 130, which provides the spatial audio processing engine 135A. The server 130 may include physical resources 780, such as at least one hardware servers, at least one storage device, at least one memory device, at least one network interface, and the like. The server may also include infrastructure, as noted above, which may include at least one operating systems 782 for the physical resources and at least one hypervisor 784 (which may create and run at least one virtual machine 786). For example, each multitenant application may be run on a corresponding virtual machine.

The systems and methods disclosed herein can be embodied in various forms including, for example, a data processor, such as a computer that also includes a database, digital electronic circuitry, firmware, software, or in combinations of them. Moreover, the above-noted features and other aspects and principles of the present disclosed implementations can be implemented in various environments. Such environments and related applications can be specially constructed for performing the various processes and operations according to the disclosed implementations or they can include a general-purpose computer or computing platform selectively activated or reconfigured by code to provide the necessary functionality. The processes disclosed herein are not inherently related to any particular computer, network, architecture, environment, or other apparatus, and can be implemented by a suitable combination of hardware, software, and/or firmware. For example, various general-purpose machines can be used with programs written in accordance with teachings of the disclosed implementations, or it can be more convenient to construct a specialized apparatus or system to perform the required methods and techniques.

Although ordinal numbers such as first, second and the like can, in some situations, relate to an order; as used in a document ordinal numbers do not necessarily imply an order. For example, ordinal numbers can be merely used to distinguish one item from another. For example, to distinguish a first event from a second event, but need not imply any chronological ordering or a fixed reference system (such that a first event in one paragraph of the description can be different from a first event in another paragraph of the description).

The foregoing description is intended to illustrate but not to limit the scope of the invention, which is defined by the scope of the appended claims. Other implementations are within the scope of the following claims.

These computer programs, which can also be referred to programs, software, software applications, applications, components, or code, include program instructions (i.e., machine instructions) for a programmable processor, and can be implemented in a high-level procedural and/or object-oriented programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives program instructions as a machine-readable signal. The term “machine-readable signal” refers to any signal used to provide machine instructions and/or data to a programmable processor. The machine-readable medium can store such program instructions non-transitorily, such as for example as would a non-transient solid state memory or a magnetic hard drive or any equivalent storage medium. The machine-readable medium can alternatively or additionally store such machine instructions in a transient manner, such as would a processor cache or other random access memory associated with one or more physical processor cores.

To provide for interaction with a user, the subject matter described herein can be implemented on a computer having a display device, such as for example a cathode ray tube (CRT) or a liquid crystal display (LCD) monitor for displaying information to the user and a keyboard and a pointing device, such as for example a mouse or a trackball, by which the user can provide input to the computer. Other kinds of devices can be used to provide for interaction with a user as well. For example, feedback provided to the user can be any form of sensory feedback, such as for example visual feedback, auditory feedback, or tactile feedback; and input from the user can be received in any form, including acoustic, speech, or tactile input.

The subject matter described herein can be implemented in a computing system that includes a back-end component, such as for example one or more data servers, or that includes a middleware component, such as for example one or more application servers, or that includes a front-end component, such as for example one or more client computers having a graphical user interface or a Web browser through which a user can interact with an implementation of the subject matter described herein, or any combination of such back-end, middleware, or front-end components. The components of the system can be interconnected by any form or medium of digital data communication, such as for example a communication network. Examples of communication networks include, but are not limited to, a local area network (“LAN”), a wide area network (“WAN”), and the Internet.

The computing system can include clients and servers. A client and server are generally, but not exclusively, remote from each other and typically interact through a communication network. The relationship of client and server arises by virtue of computer programs running on the respective computers and having a client-server relationship to each other.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” Use of the term “based on,” above and in the claims is intended to mean, “based at least in part on,” such that an unrecited feature or element is also permissible.

In view of the above-described implementations of subject matter this application discloses the following list of examples, wherein one feature of an example in isolation or more than one feature of said example taken in combination and, optionally, in combination with one or more features of one or more further examples are further examples also falling within the disclosure of this application:

Example 1: A method, comprising: receiving a spatial audio signal; processing the spatial audio signal to extract one or more sound features from the spatial audio signal; interpreting the one or more sound features; generating textual data or haptic stimuli based on the interpretation of the one or more sound features; and causing the textual data or the haptic stimuli to be sent to a user device to be presented to a hearing-impaired user.

Example 2: The method of Example 1, wherein the one or more sound features comprise a direction, a distance, and an intensity of each sound source of one or more sound sources captured by the spatial audio signal.

Example 3: The method of any of Examples 1-2, further comprising: encoding the haptic stimuli into one or more signals; and driving the one or more signals to a haptic interface of the user device.

Example 4: The method of any of Examples 1-3, wherein the one or more signals include one or more vibrations that correspond to a first direction and a first intensity of a first sound source, and wherein the one or more vibrations serve as haptic cues.

Example 5: The method of any of Examples 1-4, further comprising adjusting a duration and a frequency of the one or more vibrations based on the one or more sound features.

Example 6: The method of any of Examples 1-5, further comprising analyzing the spatial audio signal to calculate a first angle to a first sound source relative to an avatar or a user in a metaverse scene.

Example 7: The method of any of Examples 1-6, further comprising: converting, by a natural language processing module, the spatial audio signal into text; generating a textual description of a context associated with the spatial audio signal; and causing the textual description to be sent to the user device to be presented to the hearing-impaired user.

Example 8: The method of any of Examples 1-7, further comprising: assigning a grammatical category to each word in one or more sentences of the text; and assigning a part-of-speech label to each word in the one or more sentences of the text.

Example 9: The method of any of Examples 1-8, further comprising: processing linguistic content of the spatial audio signal; transcribing the linguistic content into text or braille; and generating, from the text, a textual description that conveys a context of a scene associated with the spatial audio signal.

Example 10: The method of any of Examples 1-9, further comprising processing the spatial audio signal to extract one or more environmental features which provide one or more details of an environment in which the spatial audio signal was captured.

Example 11: A system, comprising: at least one processor; and at least one memory including program instructions which when executed by the at least one processor cause operations comprising: receiving a spatial audio signal; processing the spatial audio signal to extract one or more sound features from the spatial audio signal; interpreting the one or more sound features; generating textual data or haptic stimuli based on the interpretation of the one or more sound features; and causing the textual data or the haptic stimuli to be sent to a user device to be presented to a hearing-impaired user.

Example 12: The system of Example 11, wherein the one or more sound features comprise a direction, a distance, and an intensity of each sound source of one or more sound sources captured by the spatial audio signal.

Example 13: The system of any of Examples 11-12, wherein the program instructions are further executable by the at least one processor to cause operations comprising: encoding the haptic stimuli into one or more signals; and driving the one or more signals to a haptic interface of the user device.

Example 14: The system of any of Examples 11-13, wherein the one or more signals include one or more vibrations that correspond to a first direction and a first intensity of a first sound source, and wherein the one or more vibrations serve as haptic cues.

Example 15: The system of any of Examples 11-14, wherein the program instructions are further executable by the at least one processor to cause operations comprising adjusting a duration and a frequency of the one or more vibrations based on the one or more sound features.

Example 16: The system of any of Examples 11-15, wherein the program instructions are further executable by the at least one processor to cause operations comprising analyzing the spatial audio signal to calculate a first angle to a first sound source relative to an avatar or a user in a metaverse scene.

Example 17: The system of any of Examples 11-16, wherein the program instructions are further executable by the at least one processor to cause operations comprising: converting, by a natural language processing module, the spatial audio signal into text; generating a textual description of a context associated with the spatial audio signal; and causing the textual description to be sent to the user device to be presented to the hearing-impaired user.

Example 18: The system of any of Examples 11-17, wherein the program instructions are further executable by the at least one processor to cause operations comprising: assigning a grammatical category to each word in one or more sentences of the text; and assigning a part-of-speech label to each word in the one or more sentences of the text.

Example 19: The system of any of Examples 11-18, wherein the program instructions are further executable by the at least one processor to cause operations comprising: processing linguistic content of the spatial audio signal; transcribing the linguistic content into text or braille; and generating, from the text, a textual description that conveys a context of a scene associated with the spatial audio signal.

Example 20: A non-transitory computer readable medium storing instructions, which when executed by at least one data processor, cause operations comprising: receiving a spatial audio signal; processing the spatial audio signal to extract one or more sound features from the spatial audio signal; interpreting the one or more sound features; generating textual data or haptic stimuli based on the interpretation of the one or more sound features; and causing the textual data or the haptic stimuli to be sent to a user device to be presented to a hearing-impaired user.

The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and sub-combinations of the disclosed features and/or combinations and sub-combinations of several further features disclosed above. In addition, the logic flows depicted in the accompanying figures and/or described herein do not necessarily require the particular order shown, or sequential order, to achieve desirable results. Other implementations can be within the scope of the following claims.

What is claimed:

1. A method, comprising:
receiving a spatial audio signal;
processing the spatial audio signal to extract one or more sound features from the spatial audio signal;
interpreting the one or more sound features;
generating textual data or haptic stimuli based on the interpretation of the one or more sound features; and
causing the textual data or the haptic stimuli to be sent to a user device to be presented to a hearing-impaired user.

2. The method of claim 1, wherein the one or more sound features comprise a direction, a distance, and an intensity of each sound source of one or more sound sources captured by the spatial audio signal.

3. The method of claim 1, further comprising:
encoding the haptic stimuli into one or more signals; and
driving the one or more signals to a haptic interface of the user device.

4. The method of claim 3, wherein the one or more signals include one or more vibrations that correspond to a first direction and a first intensity of a first sound source, and wherein the one or more vibrations serve as haptic cues.

5. The method of claim 4, further comprising adjusting a duration and a frequency of the one or more vibrations based on the one or more sound features.

6. The method of claim 1, further comprising analyzing the spatial audio signal to calculate a first angle to a first sound source relative to an avatar or a user in a metaverse scene.

7. The method of claim 1, further comprising:
converting, by a natural language processing module, the spatial audio signal into text;
generating a textual description of a context associated with the spatial audio signal; and
causing the textual description to be sent to the user device to be presented to the hearing-impaired user.

8. The method of claim 7, further comprising:
assigning a grammatical category to each word in one or more sentences of the text; and
assigning a part-of-speech label to each word in the one or more sentences of the text.

9. The method of claim 1, further comprising:
processing linguistic content of the spatial audio signal;
transcribing the linguistic content into text or braille; and
generating, from the text, a textual description of a context of a scene associated with the spatial audio signal.

10. The method of claim 1, further comprising processing the spatial audio signal to extract one or more environmental features which provide one or more details of an environment in which the spatial audio signal was captured.

11. A system, comprising:
at least one processor; and
at least one memory including program instructions which when executed by the at least one processor cause operations comprising:
receiving a spatial audio signal;
processing the spatial audio signal to extract one or more sound features from the spatial audio signal;
interpreting the one or more sound features;
generating textual data or haptic stimuli based on the interpretation of the one or more sound features; and
causing the textual data or the haptic stimuli to be sent to a user device to be presented to a hearing-impaired user.

12. The system of claim 11, wherein the one or more sound features comprise a direction, a distance, and an intensity of each sound source of one or more sound sources captured by the spatial audio signal.

13. The system of claim 11, wherein the program instructions are further executable by the at least one processor to cause operations comprising:
encoding the haptic stimuli into one or more signals; and
driving the one or more signals to a haptic interface of the user device.

14. The system of claim 13, wherein the one or more signals include one or more vibrations that correspond to a first direction and a first intensity of a first sound source, and wherein the one or more vibrations serve as haptic cues.

15. The system of claim 14, wherein the program instructions are further executable by the at least one processor to cause operations comprising adjusting a duration and a frequency of the one or more vibrations based on the one or more sound features.

16. The system of claim 11, wherein the program instructions are further executable by the at least one processor to cause operations comprising analyzing the spatial audio signal to calculate a first angle to a first sound source relative to an avatar or a user in a metaverse scene.

17. The system of claim 11, wherein the program instructions are further executable by the at least one processor to cause operations comprising:
converting, by a natural language processing module, the spatial audio signal into text;
generating a textual description of a context associated with the spatial audio signal; and
causing the textual description to be sent to the user device to be presented to the hearing-impaired user.

18. The system of claim 17, wherein the program instructions are further executable by the at least one processor to cause operations comprising:
assigning a grammatical category to each word in one or more sentences of the text; and
assigning a part-of-speech label to each word in the one or more sentences of the text.

19. The system of claim 11, wherein the program instructions are further executable by the at least one processor to cause operations comprising:
processing linguistic content of the spatial audio signal;
transcribing the linguistic content into text or braille; and
generating, from the text, a textual description of a context of a scene associated with the spatial audio signal.

20. A non-transitory computer readable medium storing instructions, which when executed by at least one data processor, cause operations comprising:
receiving a spatial audio signal;
processing the spatial audio signal to extract one or more sound features from the spatial audio signal;
interpreting the one or more sound features;
generating textual data or haptic stimuli based on the interpretation of the one or more sound features; and
causing the textual data or the haptic stimuli to be sent to a user device to be presented to a hearing-impaired user.
